(19) United States
(12) Patent Application Publication
(10) Pub. No.: US 2014/0274847 A1
(43) Pub. Date: Sep. 18, 2014

(54) CORROSION INHIBITORS AND METHODS OF USING SAME

(71) Applicant: CYTEC INDUSTRIES INC., Woodland Park, NJ (US)

(72) Inventors: Corey M. Regensburger, Sandy Hook, CT (US); Martin L. Cohen, White Plains, NY (US); Chester Joseph Calbick, Weston, CT (US)

(73) Assignee: CYTEC INDUSTRIES INC., Woodland Park, NJ (US)

(21) Appl. No.: 14/205,486

(22) Filed: Mar. 12, 2014

Related U.S. Application Data
(60) Provisional application No. 61/792,394, filed on Mar. 15, 2013.

(51) Int. Cl. C10M 129/72; C09K 15/06

(52) U.S. Cl. CPC C10M 129/72; C09K 15/06
USPC 508/497; 560/198; 422/7

(57) ABSTRACT

Ashless corrosion inhibitor compositions including one or more reaction product formed from the reaction of a polyether compound of formula

[chemical structure]

and a hydrocarbyl-substituted succinic anhydride of formula

[chemical structure]

are provided herein, along with lubricant compositions containing same, and methods of using same for inhibiting corrosion of a metal.

### CROSS-REFERENCE TO RELATED APPLICATIONS

This application claims benefit of priority to U.S. Provisional Application No. 61/792,394 filed Mar. 15, 2013 the content of which is incorporated herein by reference in its entirety.

### BACKGROUND OF THE INVENTION

1. Field of the Invention

The present invention generally relates to additives for lubricants. More specifically, the present invention relates to ashless corrosion inhibitor compositions and their use in lubricants. More particularly still, the present invention relates to reaction products formed between polyethers and substituted succinic anhydrides of certain chemical composition and their use as corrosion inhibitors in polyalkylene glycol oils.

2. Description of Related Art

Lubricants desirable for use in automotive, industrial, marine and metal working applications possess the following properties: high boiling point; low freezing point; high viscosity index; thermal stability; corrosion inhibition; and high resistance to oxidation. Typically these lubricants contain more than 50% of a base oil and less than 50% of an additive package, which impart desirable characteristics (e.g., deliver reduced friction and wear, increased viscosity, improved viscosity index, and resistance to corrosion, oxidation, aging or contamination).

Lubricants typically include a Group I-V base oil (commonly referred to as “base oil”) and one or more additives that impart or enhance certain properties of the lubricant. The base oil can be synthetic or petroleum-based, i.e., naturally occurring. Group III-V base oils are typically used in high performance applications, and therefore the additives used with Group III-V base oils are desired to be high performing, i.e., provide the desired characteristic while not interfering with the performance of the lubricant or the application in which it is used. As more and more sophisticated technology is utilized, the demand for high performing lubricants has increased. Thus, many applications now require or benefit from lubricants that include Group III-V base oils.

Polyalkylene glycol oils (PAGs) are widely used in the lubricants industry as synthetic base oils or fluids, or as additives in lubricant blend compositions. The predominant chemistries used are random copolymers of ethylene oxide (EO) and propylene oxide (PO), and also homo-polymers of propylene oxide.

PAGs are characterized by inherent low friction properties and good low and high temperature viscosity properties which promote excellent hydrodynamic film formation between moving parts. PAG-based engine lubricant oils find an increasing original equipment manufacturer (OEM) interest due to their intrinsic properties in relation to an increasing number of new performance criteria requested by automotive engine design departments.

PAGs are also known to be suitable for use in a variety of other application such as for use in hydraulic fluids, coating fluids, metalworking fluids, heat transfer fluids, process fluids, quenchants, and as high-temperature lubricants, compressor lubricants, refrigeration lubricants, food grade lubricants, 2-cycle engine lubricants, rubber lubricants, textile fiber/machine lubricants, and as solid lubricant dispersions. The synthetic fluids offer superior oil life, load carrying and anti-wear performance and perform well at high and low temperatures.

However, a need exists for additive packages which are soluble in PAGs, preferably where the package itself meets certain bio-no-tox criteria or will not deteriorate biological and toxicological (“bio-no-tox”) properties of a base oil below criteria set forth in, for example, European Community directive EC/1999/45, and which are adapted to the specific chemistry and oxidation kinetics of PAGs in order to meet critical application performance requirements for use in internal combustion engine oils and exceed those known from hydrocarbons.

While corrosion inhibitors are generally well known to those skilled in the art and are used in many types of lubricants (such as with any Group I-V base oil, in hydraulic fluids, and greases) as desirable additives because they decrease the rate at which materials (typically metal) in contact with the lubricant degrade due to chemical reaction with its environment, additives of the prior art have proven incompatible with water soluble lubricants such as PAGs in that they form hazy mixtures with the base oil, or lack desired performance characteristics. Thus, an effective corrosion inhibitor additive for use in water-soluble lubricants has eluded the industry.

Accordingly, new corrosion inhibitor additives, which would meet various performance criteria for use in a variety of applications from engine-lubricant oils to food grade lubricants, or that are compatible with water-soluble lubricants, would find rapid acceptance in a variety of industries.

### SUMMARY OF THE INVENTION

An effective corrosion inhibitor for use with a variety of lubricants including, for example, polyalkylene glycols, has now been discovered. Specifically, reacting an alkenylsuccinic anhydride with a polyalkylene glycol oil surprisingly creates a reaction product having desirable corrosion inhibiting properties, and provides a compound that is compatible with the base oil, which shows increased efficacy in inhibiting corrosion of metals.

Thus, in one aspect the present invention provides a reaction product having a polyether component of formula

[chemical structure]

where

R is chosen from C₁-C₃₀ hydrocarbyl;

X is chosen from OH, NHR¹, wherein R¹ is H or C₁-C₃₀ hydrocarbyl;

y is an integer from 2 to 4;

m and n are integers independently chosen from 0 to 40, provided that at least two of m or n are present, and wherein when both are present the distribution of m and n can be random or in any specific sequence; and

p is 1 to 4;

reacted with a substituted succinic anhydride component of formula

[chemical structure]

where

R² is an optionally substituted C₁-C₁₀₀ alkyl or alkenyl, and

wherein the reaction product is an ashless corrosion inhibitor.

In another aspect, the present invention provides lubricant compositions having a base oil present in a major amount; and a corrosion inhibiting amount of a reaction product according to the present invention, which reaction product is present in a minor amount and is compatible with the base oil.

The reaction products and lubricant compositions according to the present invention are useful as ashless corrosion inhibitors for preventing degradation (e.g., oxidation/corrosion) of metals. Such reaction products and lubricants will have a variety of uses including, for example, engine lubricant oils, hydraulic oils, gear oils, and compressor oils for equipment used in the food processing and packaging industry. Accordingly, in another aspect, the present invention provides methods for inhibiting corrosion of a metal by contacting a surface of the metal with a corrosion inhibiting amount of a reaction product or lubricant composition described according to the present invention, thereby inhibiting corrosion of the metal.

These and other objects, features and advantages of this invention will become apparent from the following detailed description of the various aspects of the invention taken in conjunction with the accompanying Figures and Examples.

### BRIEF DESCRIPTION OF THE DRAWINGS

The following figures are included to illustrate certain embodiments of the present invention, and should not be viewed as exclusive. The subject matter disclosed is capable of considerable modification, alteration, and equivalents in form and function, as will occur to those skilled in the art and having the benefit of this disclosure.

FIGS. 1A-1C demonstrate steel coupons after performing the ASTM D665B corrosion test. The test is performed with (or without) a reaction product formed from C₂₀-C₂₄ alkenyl succininc anhydride and UCON™ 50-HB-260 PAG oil, which reaction product is loaded at 1.0 wt. % into UCON™ 50-HB-260 PAG oil base stock as a lubricant. (A) Control—steel coupon with 50-HB-260 PAG oil w/out reaction product; (B) steel coupon with UCON™ 50-HB-260 PAG oil containing reaction product; coupon rinsed with acetone; (C) steel coupon with UCON™ 50-HB-260 PAG oil containing reaction product; coupon wiped with acetone wetted KimWipe.

### DETAILED DESCRIPTION OF CERTAIN EMBODIMENTS OF THE INVENTION

As summarized above, the present invention pertains to the discovery of new compositions useful as corrosion inhibitors. As described more fully below, the inventors have surprisingly discovered that a reaction product between a polyether component and a substituted succinic anhydride as described in detail herein prove useful as ashless corrosion inhibitors and are suitable for formulating with a variety of lubricants including various base oils and greases for use in a multitude of applications.

Accordingly, in one aspect the present invention provides a reaction product including a polyether component of formula

[chemical structure]

where

R is chosen from C₁-C₃₀ hydrocarbyl;

X is chosen from OH, NHR¹, wherein R¹ is H or C₁-C₃₀ hydrocarbyl;

y is an integer from 2 to 4;

m and n are integers independently chosen from 0 to 40, provided that at least two of m or n are present, and wherein when both are present the distribution of m and n can be random or in any specific sequence; and

p is 1 to 4;

reacted with a substituted succinic anhydride component of formula

[chemical structure]

where R² is an optionally substituted C₁-C₁₀₀ alkyl or alkenyl, and

wherein the reaction product is an ashless corrosion inhibitor.

The term “ashless” as used herein, means that the composition contains no metals which are known to be environmentally undesirable and/or can have undesirable performance, e.g., accelerate formation of deposits on a metal surface.

As used herein, the term “hydrocarbyl” encompasses aliphatic, alicyclic and aromatic groups having an all-carbon backbone and consisting of carbon and hydrogen atoms. Examples of hydrocarbyl groups include alkyl, alkoxy, alkenyl, cycloalkyl, cycloalkenyl, carbocyclic aryl, carbocyclic aralkyl, and alkaryl. The term alkyl or alkenyl can include linear or branched groups.

In certain embodiments, the polyether component has a weight average molecular weight up to 10,000 Daltons and includes polyalkylene glycols (PAGs). Various PAGs suitable for use as the polyether component as described herein are well known to those of ordinary skill in the art and include monol- and/or diol-initiated copolymers of ethylene oxide (EO) and/or propylene oxide (PO). Such PAGs are disclosed in at least U.S. Pat. Nos. 8,309,500 and 8,357,644, and include both random and/or block copolymers, as well as EO or PO homopolymers. Techniques for preparing suitable polyethers from mixed 1,2-oxides are discussed, for example, in U.S. Pat. No. 8,357,644.

In preferred embodiments, PAGs for use as a polyether component of the reaction product according to the invention include those produced by the polymerization of ethylene oxide (EO) and propylene oxide (PO) onto an initiator, such as a lower acyclic alcohol (e.g., a C₁-C₁₂ alcohol including methanol, ethanol, propanol, butanol, pentanol, hexanol, neopentanol, isobutanol, decanol, dodecanol, and the like). Thus, while the substituent R of the polyether formula described herein can be chosen from a C₁-C₃₀ hydrocarbyl, in certain embodiments R is preferably chosen from a C₁-C₁₂ alkyl.

In certain embodiments the polyether component is a monol-initiated EO/PO random copolymer (i.e., where X═OH, y=3, and p=1 according to the polyether formula described herein). In other embodiments, a diol-started polyether is preferred (i.e., where X═OH and p=2). In a particular embodiment, the initiator is butanol (i.e., where R=butyl according to the polyether formula described herein).

While the polyether component according to the formula described herein can include EO/PO copolymers of up to a weight average molecular weight of 10,000 Daltons, the distribution of m and n can be random or in any specific sequence. Thus, in some embodiments the distribution of m and n is random and the weight ratio of ethylene oxide (EO) to propylene oxide (PO) (EO:PO), is 50:50 wt. %. In other embodiments, the EO:PO content is 75:25 wt. %.

A variety of suitable PAG products available for use as the polyether component to make the reaction products according to the invention are known by those of skill in the art and are commercially available including, but not limited to, those products sold under the following brand names: PLURIOL™ A750E; PLURACOL™ WS55, WS100, WS170, B11/25, B11/50, B32/50; BREOX™ A299; BREOX™ 50A; PPG-33-series; UCON™ 50-HB series; UCON™ OSP series; SYNALOX™ 50-xxB series; SYNALOX™ 100-xxB series; GLYGOYLE™ HE460; D21/150; PLURONIC™ 450PR, PLURONIC™ 600PR; TERRALOX™ WA46, TERRALOX™ WA110; SYNALOX™ 40-D150; Polyglycol B01/20, B01/40, B01/50, B15, B35; UCON™ LB65, LB125, LB165, LB285, W1285, W1625; P41/200; PLURONIC™ GENAPOL™; WAKO T01/15, T01/35, T01/60; LUPRANOL™ 9209 and 3300; and SELEXOL™, which are all available from Dow Chemicals.

In certain embodiments, the polyether component used to make the reaction product according to the present invention is UCON™ 50-HB-260. In another embodiment, the polyether component is UCON™ 50-HB-5100. In still other embodiments, the polyether component is any of the SYNALOX™ series of water soluble PAGs, or UCON™ OSP series of oil soluble PAGs.

In other embodiments, the polyether component according to the formula described herein includes polyetheramines. Various polyetheramines suitable for use as the polyether component as described herein are well known to those of ordinary skill in the art and include those formed via monol-initiated copolymers of ethylene oxide (EO) and/or propylene oxide (PO), followed by conversion of the resulting terminal hydroxyl group to an amine group. Such polyetheramines include both random and/or block copolymers of EO/PO, as well as EO or PO homopolymers.

Accordingly, many of the characteristics of the polyetheramines used as the polyether component are similar to the characteristics of the PAGs discussed above. Thus, in certain embodiments, R is preferably chosen from a C₁-C₁₂ alkyl and the distribution of m and n is random or specific. In a particular embodiment, the initiator is methanol (i.e., where R=methyl according to the polyether formula described herein), and the weight ratio of ethylene oxide (EO) to propylene oxide (PO) (EO:PO), is 31:10 wt. %.

A variety of suitable polyetheramine products available for use as the polyether component to make the reaction products according to the invention are known by those of skill in the art and are commercially available including, but not limited to, those products sold under the JEFFAMINE® MONOAMINES (M series) brand name (available from Huntsman). In a particular embodiment, the polyetheramine is JEFFAMINE® M-2070.

In certain embodiments the polyether component has a weight average molecular weight from 200 to 7,500 Daltons, and more preferably from 500 to 5,500 Daltons. In specific embodiments of the invention, the polyether component has a weight average molecular weight of 970 Daltons; 3,930 Daltons; or 2,000 Daltons.

The succinic anhydride component used to form the reaction product of the corrosion inhibitor composition is a hydrocarbyl-substituted succinic anhydride compound according to the formula as described above. In certain embodiments, R² is a C₁₂-C₂₄ alkyl or alkenyl. In other embodiments, R² is a C₁₈-C₂₄ alkyl or alkenyl.

Particular examples of the hydrocarbyl-substituted succinic anhydride include, but are not limited to, C₂₀-C₂₄ alkenyl succinic anhydride, octadecenyl succinic anhydride, hexadecenyl succinic anhydride, eicosenyl succinic anhydride, n-tetradecenyl succinic anhydride, dodecenyl succinic anhydride, tetrapropenyl succinic anhydride, polyisobutylene succinic anhydride, and mixtures thereof. A variety of such hydrocarbyl-substituted succinic anhydrides as contemplated for use as a component in producing the reaction product according to the present invention are commercially available and will be known by those of ordinary skill in the art.

The reaction products described herein can be manufactured by combining the polyether starting material and the hydrocarbyl-substituted succinic anhydride starting material according to the formulas as described herein with a suitable acid acceptor and mixing the same in concentrations, and at suitable time and temperature, that allow the two components to react and form the reaction product. An example of a suitable acid acceptor for use in forming the reaction products according to the invention is triethylamine.

To form the reaction product, the hydrocarbyl-substituted succinic anhydride and the polyether starting materials can typically be combined in a molar ratio of about 10:1 to about 1:10, or any value therebetween. The molar ratio of acid acceptor to combined amount of hydrocarbyl-substituted succinic anhydride and polyether starting materials may be varied from 0.05 to 1.0. However, the invention is not limited in this regard since any molar ratio may be utilized in order to form the reaction product. While equimolar amounts of reactants can be used, it is also contemplated that an excess of the polyether starting material or of the hydrocarbyl-substituted succinic anhydride starting material may be used in forming the reaction product of the corrosion inhibitor composition.

The temperature and time at which the reaction is run can be varied from 20° C. to 100° C., and from 10 min. to 10 hours, respectively. In certain embodiments, the reactants are present in a molar ratio of hydrocarbyl-substituted succinic anhydride:acid acceptor:polyether of from 1.0:1.0:1.2, respectively, and the reaction is run for 2 hours at 60° C. The reactants can be combined in any sequence and the mixing can be performed by any acceptable mixing process. The reaction product can be taken up in ethyl acetate or other suitable solvent and is shaken with 10% aqueous HCl for maximum efficacy. The organic phase can then be separated off and dried over anhydrous magnesium sulfate or other suitable means. The solvent can then be removed by any means known to those of skill in the art, such as by rotary evaporator.

Mixtures of the polyether component and of the hydrocarbyl-substituted succinic anhydride according to the formulas as described herein are also made for comparison purposes. Such mixtures are made using the molar ratios of reactants described herein and for the contemplated time and temperature, except that no acid acceptor is included. The mixtures of polyether and hydrocarbyl-substituted succinic anhydride are not found to be effective as corrosion inhibitors.

In another aspect, the invention provides lubricant compositions having a corrosion inhibiting amount of a reaction product according to the present invention, which reaction product is present as a minor amount (i.e., less than 50 wt. % based upon the total lubricant oil base stock weight) and is compatible with the lubricant.

The term “lubricant” as used herein, means a solid or a liquid substance that can be utilized to reduce friction between moving surfaces, transport foreign particles (e.g., debris), transfer heat, transmit power, and the like and typically includes a base oil, grease, or hydraulic fluid (present in a major amount, i.e., at least 50 wt. % based upon the total lubricant oil base stock weight), at least one of the aforementioned reaction products according to the invention, and one or more additives. The base oil may be a Group I, II, III, IV, or V base oil. The term “Group I-V base oil” or “Group I, II, III, IV or V base oil” refers to the nomenclature of different types of base oils established by the American Petroleum Institute (API). Group III-V oils are typically used in demanding, high performance applications. Thus, lubricants that contain a Group III-V oil must perform efficiently and at full desired performance for the life of the lubricant, and therefore any compounds present in the lubricant, e.g., the reaction product, must also perform efficiently and at full desired performance for the life of the lubricant. It has been surprisingly found that lubricants containing a reaction product formed between hydrocarbyl-substituted succinic anhydrides and polyether compounds according to the formulas as described herein exhibit better corrosion inhibition than lubricants containing mixtures of these components, or of lubricants containing only one of these components.

The base oil contemplated for use with the lubricant compositions according to the invention may be any Group I-Group V oil, or a combination of any Group I-V base oils.

While the reaction products according to the invention are contemplated to be compatible with any base oil, Group V PAG oils are preferred base oils and stock fluids in certain embodiments. Generally, these PAG oils are the same as those discussed above in relation to the polyether component used to form the reaction products according to the invention. Thus, in certain embodiments the base oil is structurally identical to the polyether component used to make the reaction product that serves as the ashless corrosion inhibitor. Accordingly, in one embodiment both the polyether component used to produce the reaction product and the base oil used to formulate the lubricant can be UCON™ 50-HB-260 PAG. In a particular such embodiment, the hydrocarbyl-substituted succinic anhydride is C₁₈ alkenylsuccinic anhydride.

In other embodiments, the base oil can be a Group IV polyalphaolefin (PAO), such as SpectrSyn™ 6 (commercially available from Exxon Mobile Chemical).

As used herein, to say that the reaction products according to the invention are “compatible” with a base oil or grease (i.e., lubricant) means that they are capable of efficient integration into the base oil or grease without modification or conversion and are capable of forming a chemically stable system and maintain desired performance characteristics (i.e., corrosion inhibition).

The corrosion inhibiting amount of the reaction product according to the invention can be any amount or concentration (often referred to as the “treat rate”) of the reaction product that inhibits corrosion. In an embodiment, the corrosion inhibiting amount of the reaction product composition is between about 0.01 wt. % and about 10 wt. %, and any value there between, based on the total weight of the lubricant composition. In certain embodiments, the reaction product is present in a corrosion inhibiting amount of from 0.05 wt. % to 10 wt. % based on the total weight of the lubricant composition, and preferably from 0.1 wt. % to 5 wt. % based on the total weight of the lubricant composition; and more preferably from 0.5 wt. % to 2 wt. % based on the total weight of the lubricant composition. While certain examples of the corrosion inhibiting amount have been provided, the lubricant is not limited to the specific examples as the corrosion inhibiting amount can be more or less than the examples provided.

The lubricant compositions may also contain one or more additives known to those of ordinary skill in the art. Additives can include, but are not limited to, one or more of metallic detergents, ashless dispersants, friction modifiers, additional corrosion inhibitors, extreme pressure agents, viscosity index improvers, pour point depressants, antioxidants, acid scavenger, antiwear agents, and demulsifers. The total amount or concentration of the additives in the lubricant will vary between lubricants and/or additives. When used, those of skill in the art will appreciate that the amount of particular additive to be employed can be attained through reference to the literature or through no more than routine experimentation.

A corrosion inhibiting amount of the reaction product composition according to the invention combined with a Group I-V base oil, or a grease, to form a lubricant that can be used in various applications and systems, such as, but not limited to combustion engines, hydraulic fluids, coating fluids, metalworking fluids, heat transfer fluids, process fluids, quenchants, and as high-temperature lubricants, compressor lubricants, refrigeration lubricants, food grade lubricants, 2-cycle engine lubricants, rubber lubricants, textile fiber/machine lubricants, and as solid lubricant dispersions, and the like is also provided by the present invention. Combination of the composition described above with the Group I-V base oil or grease reduces or prevents corrosion (“corrosion inhibition”) of a metal that is in contact with the lubricant. Such lubricants can be utilized in various applications or systems where ash, i.e., undesirable metals, is a concern, e.g. high performance lubricants.

Either the lubricant compositions or the reaction products as described herein can be utilized to reduce or prevent corrosion of a metal by contacting the lubricant or the reaction product to a surface of the metal. For example, it is contemplated that the lubricants described herein can be in the form of a motor oil, gear oil, turbine oil, compressor oil, food grade lubricant, hydraulic fluid, grease, or any of the like in which the amount of corrosion experienced by the metal contacted by the lubricants will be reduced or prevented. It is also contemplated that the reaction product or lubricant containing such reaction product as described herein can be applied directly to a surface of a metal in order to inhibit corrosion of the metal (i.e., as a rust inhibitor).

### EXAMPLES

The following examples are provided to assist one skilled in the art to further understand certain embodiments of the present invention. These examples are intended for illustration purposes and are not to be construed as limiting the scope of the present invention.

Throughout the Examples, the performance of a lubricant containing a reaction product of an alkenylsuccinic anhydride and a polyalkylene glycol oil (as identified below in the Tables) in reducing or preventing, i.e., inhibiting, corrosion of a metal surface is assessed by making the reaction product and combining it with a base oil to form a lubricant as described below. The performance of lubricant made with mixtures of these starting components is also provided. The particular components used in the lubricant are provided in the Tables below.

The lubricant is tested and analyzed according to the publicly available protocol of the standard test ASTM D665B, which is a corrosion inhibition test. The results of ASTM D665B test are reported on a Pass/Fail basis where a “pass” requires no evidence of corrosion or pitting after the test is constructed. If there is evidence of corrosion or pitting, the result of the ASTM D665B test is a “fail”.

### Example 1

### Preparation of Reaction Products

Reaction products formed from monol-initiated ethylene oxide/propylene oxide (EO/PO) copolymers and hydrocarbyl-substituted succinic anhydrides according to the invention are made via the synthesis pathway below:

[chemical structure]

Hydrocarbyl-substituted succinic anhydrides (wherein R¹═C₁-C₁₀₀ alkyl or alkenyl, and mixtures thereof) and triethylamine (as acid acceptor) are reacted with a hydroxy-terminated polyalkyleneglycol oil such as Dow Chemical's UCON™ 50-HB-260 (i.e., R═C₄H₉, weight ratio of m:n=50:50, and weight average MW=970 Daltons) in a molar ratio of 1.0:1.0:1.2 at 60° C. for 2 hours. The reaction product is taken up in ethyl acetate, shaken with 10% aqueous HCl and the organic phase separated off and dried over anhydrous magnesium sulfate. The solvent is removed by rotary evaporator to give the reaction product. The reaction is confirmed by FTIR spectroscopy and efficacy of the reaction product as a corrosion inhibitor in PAG oil is demonstrated using the publicly available ASTM D665B Oil Corrosion Test.

Diol-initiated EO/PO copolymers (i.e., polyalkylene glycols having 2 terminal hydroxyl groups) such as UCON™ 75-H Fluids or SYNALOX™ 40-D100 or 40-D150, can also be made according to the process exemplified above by substituting the monol-initiated EO/PO copolymer above with a diol-initiated EO/PO copolymer as starting material.

Reaction products formed from amine-terminated polyether and hydrocarbyl-substituted succinic anhydrides are made according to the following synthesis pathway:

[chemical structure]

The process and conditions are the same as above, except that the hydroxy-terminated polyether starting material (PAG oil) is replaced with a polyetheramine such as JEFFAMINE® M-2070 (i.e., R=methyl; weight ratio of m:n=31:10, and weight average MW=approx. 2000) (available from Huntsman).

### Example 2

### Preparation of Mixtures

Mixtures of hydrocarbyl-substituted succinic anhydrides and polyethers are prepared using the starting components above, except that no acid acceptor such as triethylamine is added. The mixtures are aged at room temperature and 50° C. for 6 months or more without spontaneously forming reaction products in any significant amount.

### Example 3

### Preparation of Lubricants

Reaction products or mixtures are prepared according to Examples 1 or 2 as desired and are added to a base oil or other lubricant stock and are mixed or formulated until homogenized. The amount of reaction product or mixture added to the lubricant (“treat rate”) represents the amount of reaction product or mixture (as a percentage by weight based on the total weight of the lubricant). Exemplary treat rate percentages of the reaction product or mixture added to the lubricant are provided in the Examples below.

### Examples 4-26

### Performance of Lubricants using a Group V PAG Base Oil

The reaction products, mixtures, and lubricants of Examples 4-26 are made according to the methods described herein for Examples 1-3, with the particular hydrocarbyl-substituted succinic anhydride and polyether components identified in Table 1 below. In Examples 21-23, no polyether component is admixed with the hydrocarbyl-substituted succinic anhydride. Accordingly, the treat rates are lower but represent the same amount of hydrocarbyl-substituted succinic anhydride used in a higher dose of the corresponding reaction product. For Examples 4-26 all reaction product or mixtures were added to UCON™ 50-HB-260 (available from Dow Chemical) base stock (a water soluble PAG) to form the lubricant composition.

The test used to evaluate these compositions as effective corrosion inhibitors is the standard version of the publicly available ASTM D665B corrosion test run for 4 hours using standardized synthetic sea water. However, this corrosion test is primarily designed for use with hydrophobic testing mediums, and specifically mineral oils. Thus, atypical results are seen when testing in a water soluble PAG fluids such as UCON™ 50-HB-260, in which there is only one phase instead of two. As a result, testing of water soluble materials often produces a test coupon covered in some form of thin film surface coating.

In order to properly evaluate these materials for corrosion protection while keeping in accordance with the ASTM methodology, the resulting thin film on the metal coupons is cleaned off by wiping with lint-less tissues and acetone (or other appropriate solvent) to remove any benign surface deposits not deemed to be corrosion. After this additional step, the exposed metal surface is then visually analyzed for corrosion, first by the naked eye of the tester.

Coupons are subsequently analyzed using a low powered microscope or other magnification device to confirm the presence of any obvious evidence of corrosion associated with the removal of material. Specifically, in cases where a metal coupon yields heavy surface deposits in a pattern, the surface underneath in investigated for the confirmation of pitting as described in the ASTM methodology. When analyzing the metal surface using a magnification tool, failure is indicated by a large area of uniform micropitting. Isolated instances where pitting is observed, especially when unaccompanied by the removal of correlated material, shall be ignored as they would not otherwise be noticed or considered failure by the ASTM methodology.

The purpose of analyzing the surface is to determine if the material on the surface is truly corrosion product or if the metal is actually protected and the removed material is insoluble benign surface deposits. At this point, a Pass (P) or Fail (F) rating is assigned based on perceived performance. This rating is used in Table 1 below to determine a certain level of protection that can distinguish formulations as having the basic functionality of a corrosion inhibitor.

TABLE 1
Performance of Reaction products and Mixtures in
UCON ™ 50-HB-260 water soluble PAG fluid.

| | R² group | | | | | | |
|---|---|---|---|---|---|---|---|
| | of succinic | Polyether | Poly- | EO | PO | Treat | P/F |
| Example | anhydride | reactant | ether | wt. | wt. | Rate | Post |
| No. | reactant | UCON ™ | MW | % | % | (wt. %) | Wipe* |
| 4 | C20-24 | HB-5100 | 3930 | 50 | 50 | 0.5 | P |
| 5 | C12B | HB-260 | 970 | 50 | 50 | 3.0 | P |
| 6 | C12L | HB-260 | 970 | 50 | 50 | 0.5 | P |
| 7 | C12L | HB-260 | 970 | 50 | 50 | 1.0 | P |
| 8 | C18 | HB-260 | 970 | 50 | 50 | 0.5 | P |
| 9 | C18 | HB-260 | 970 | 50 | 50 | 1.0 | P |
| 10 | C20-24 | HB-260 | 970 | 50 | 50 | 0.5 | P |
| 11 | C20-24 | HB-260 | 970 | 50 | 50 | 1.0 | P |
| 12 | C72 | HB-260 | 970 | 50 | 50 | 1.0 | P |
| | (PIBSA) | | | | | | |
| 13 | C18 | HB-170 | 750 | 50 | 50 | 1.0 | P |
| 14 | C12L | HB-100 | 520 | 50 | 50 | 1.0 | P |
| 15 | C20-24 | 75-H-450 | 980 | 75 | 25 | 0.5 | P |
| 16 | C20-24 | 75-H-450 | 980 | 75 | 25 | 1.0 | P |
| 17 | C18 | LB-165 | 740 | 0 | 100 | 0.5 | P |
| 18 | C12 | Propylene | 76 | 0 | 100 | 0.5 | F |
| | | Glycol | | | | | |
| 19 | C20-24 | Propylene | 76 | 0 | 100 | 1.0 | F |
| | | Glycol | | | | | |
| 20 | none | HB-260 | 970 | 50 | 50 | 0 | F |
| | | (control) | | | | | |
| 21 | C18 | None | | | | 0.2 | F |
| 22 | C20-24 | None | | | | 0.5 | F |
| 23 | C72 | None | | | | 0.3 | F |
| | (PIBSA) | | | | | | |
| 24 | C20-24 | +HB-260 | 970 | 50 | 50 | 0.5 | F |
| 25 | C20-24 | +HB-260 | 970 | 50 | 50 | 1.0 | F |
| 26 | C20-24 | +HB-260 | 970 | 50 | 50 | 3.0 | F |

Where L = linear, B = branched, P = pass, F = fail; + denotes a mixture of the polyether and hydrocarbyl-substituted succinic anhydride.

The results of Table 1 demonstrate that lubricant compositions containing the reaction product formed from a polyether component according to the formula as described herein and a hydrocarbyl-substituted succinic anhydride (e.g., Examples 4-17) are effective as corrosion inhibitors in Group V oils, such as water soluble PAGs.

The results also demonstrate that lubricant compositions without a hydrocarbyl-substituted succinic anhydride or without a polyether (e.g., Examples 20-23), or with only a mixture of a polyether component and a hydrocarbyl-substituted succinic anhydride component (e.g., Examples 24-26), are ineffective as corrosion inhibitors.

### Examples 27-29

### Performance of Lubricants Using Other Base Oils

The reaction products and lubricants of Examples 27-29 are made according to the methods described herein for Examples 1 and 3, with the particular hydrocarbyl-substituted succinic anhydride and polyether components identified in Table 2 below. The reaction products are then added to a variety of base oil stocks (also identified in Table 2) and the resulting lubricant formulations are tested and analyzed according to the ASTM D665B test as discussed above. Results of these tests are provided in Table 2 below.

TABLE 2

| | | | | R² group of | PAG | Treat | |
|---|---|---|---|---|---|---|---|
| Example | | Oil | | succinic anhydride | reactant | Rate | |
| No. | Base Oil | Type | Solubility | reactant | (UCON ™) | (wt. %) | P/F |
| 27 | Group IV | PAO | Oil | C18 | 50-HB-260 | 0.6 | P |
| 28 | Group IV | PAO | Oil | C18 | OSP-32 | 0.6 | P |
| 29 | Group V | PAG | Water | C18 | 50-HB-260 | 0.5 | P |

Group IV base oil = polyalphaolefin (commercially available as SpectraSyn ™ 6 PAO oil from Exxon Mobil Chemicals);
Group V base oil = polyalkylene glycol oil (commercially available as UCON ™ HB-5100 PAG oil from Dow Chemicals).

The results of Table 2 demonstrate that reaction products formed from a polyether component according to the formula as described herein and a hydrocarbyl-substituted succinic anhydride are effective as corrosion inhibitors in a variety of base oils or fluids and are even compatible with base oils where the polyether component is not identical to that of the base oil.

As employed above and throughout the disclosure, various terms are provided to assist the reader. Unless otherwise defined, all terms of art, notations and other scientific terminology used herein are intended to have the meanings commonly understood by those of skill in the chemical arts. As used herein and in the appended claims, the singular forms include plural referents unless the context clearly dictates otherwise. All numbers expressing quantities of ingredients, reaction conditions, and so forth used in the specification and claims are to be understood as being modified in all instances by the term “about.” Similarly, all numbers expressed in a range as indicated by the word “between” include the upper and lower limits in the range. Accordingly, unless indicated to the contrary, the numerical parameters set forth in the specification and attached claims are approximations that may vary depending upon the desired properties sought to be obtained by the present invention.

Various patent and/or scientific literature references have been referred to throughout this application. The disclosures of these publications as they relate to the subject matter of the present invention are hereby incorporated by reference as if written herein. In the case of conflicting terms, the terms of this document will take preference. In view of the above description, as well as the accompanying figures and examples, one of ordinary skill in the art will be able to practice the invention as claimed without undue experimentation.

Although the foregoing description has shown, described, and pointed out the fundamental novel features of the present invention, it will be understood that various omissions, substitutions, and changes in the form of compositions, as well as the uses thereof, may be made by those skilled in the art, without departing from the scope of the present teachings. Consequently, the scope of the present invention should not be limited to the foregoing discussion, but should be defined by the appended claims.

What is claimed is:

1. A reaction product comprising:
a polyether component of formula [chemical structure]
where
R is chosen from C₁-C₃₀ alkyl;
X is chosen from OH, NHR¹, wherein R¹ is H or C₁-C₃₀ hydrocarbyl;
y is an integer from 2 to 4;
m and n are integers independently chosen from 0 to 40, provided that at least two of m or n are present, and wherein when both are present the distribution of m and n can be random or in any specific sequence; and
p is 1 to 4;
reacted with a substituted succinic anhydride component of formula [chemical structure]
where
R² is an optionally substituted C₁-C₁₀₀ alkyl or alkenyl; and
wherein the reaction product is an ashless corrosion inhibitor.

2. A reaction product according to claim 1, wherein p is 1.

3. A reaction product according to claim 1, wherein p is 2.

4. A reaction product according to claim 1, wherein R is butyl, X is OH, and y is 3.

5. A reaction product according to claim 2, wherein R is methyl, X is NH₂, and y is 3.

6. A reaction product according to claim 1, wherein the polyether component has a weight average molecular weight from 200 to 7,500 Daltons.

7. A reaction product according to claim 6, wherein the polyether component has a weight average molecular weight of from 500 to 5,500 Daltons.

8. A reaction product according to claim 2, wherein y is 3, the weight ratio of the ethylene oxide:propylene oxide is 50:50 and the weight average molecular weight of the polyether component is 970 Daltons.

9. A reaction product according to claim 2, wherein y is 3, the weight ratio of the ethylene oxide:propylene oxide is 50:50 and wherein the weight average molecular weight of the polyether component is 3,930 Daltons.

10. A reaction product according to claim 5, wherein y is 3, the weight ratio of the ethylene oxide:propylene oxide is 31:10 and the weight average molecular weight of the polyether component is 2,000 Daltons.

11. A reaction product according to claim 1, wherein R² is a C₁₂-C₂₄ alkyl or alkenyl.

12. A reaction product according to claim 11, wherein R² is a C₁₈-C₂₄ alkyl or alkenyl.

13. A reaction product according to claim 8, wherein R² is C₁₈ alkyl or alkenyl.

14. A reaction product according to claim 1, wherein the succinic anhydride component is polyisobutylene succinic anhydride.

15. A reaction product according to claim 1, wherein the polyether component is a random copolymer.

16. A lubricant composition comprising:
a base oil present in a major amount; and
a corrosion inhibiting amount of a reaction product as defined by claim 1, which reaction product is present as a minor amount and is compatible with the base oil.

17. A lubricant composition according to claim 16, wherein the base oil is comprised of a polyether identical to the polyether component used to form the reaction product.

18. A lubricant composition according to claim 16, wherein the base oil is a polyalkylene glycol having a weight average molecular weight from 200 to 7,500 Daltons.

19. A lubricant composition according to claim 18, wherein the weight average molecular weight of the polyalkylene glycol is from 500 to 5,500 Daltons.

20. A lubricant composition according to claim 18, wherein the weight average molecular weight of the polyalkylene glycol is 970 Daltons.

21. A lubricant composition according to claim 20, wherein the reaction product is as defined by claim 13.

22. A lubricant composition according to claim 16, wherein the reaction product is present in a corrosion inhibiting amount of from 0.05 wt. % to 10 wt. % of the total lubricant composition.

23. A lubricant composition according to claim 22, wherein the reaction product is present in a corrosion inhibiting amount of from 0.1 wt. % to 5 wt. % of the total lubricant composition.

24. A lubricant composition according to claim 23, wherein the reaction product is present in a corrosion inhibiting amount of from 0.5 wt. % to 2 wt. % of the total lubricant composition.

25. A lubricant composition according to claim 16 further comprising an additive composition selected from the group consisting of metallic detergents, ashless dispersants, friction modifiers, extreme pressure agents, viscosity index improvers, pour point depressants, antioxidants, antiwear agents, demulsifiers, and combinations thereof.

26. A method of inhibiting corrosion of a metal, the method comprising:
contacting a surface of the metal with a reaction product as defined by claim 1, thereby inhibiting corrosion of the metal.
